(19) United States
(12) Patent Application Publication
(10) Pub. No.: US 2007/0168375 A1
(43) Pub. Date: Jul. 19, 2007

(54) Operating environment system and method for executing workflow on computer

(75) Inventor: Chia Wei Yu, Hsinchu (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Industrial Technology Research, Hsinchu (TW)

(21) Appl. No.: 11/378,668

(22) Filed: Mar. 17, 2006

(30) Foreign Application Priority Data
Dec. 29, 2005 (TW) 094147330

(51) Int. Cl. G06F 7/00

(52) U.S. Cl. 707/101

(57) ABSTRACT

Disclosed is an operating environment system and method for an improved efficiency of a workflow executed on a computer by a user, the method being allowed to be executed on the operating environment system, comprising a plurality of soft applications and an integrated operating environment, comprising an action model module described in a data structure form, a plug-in component module monitoring the user's operating status and intercepting and transmitting an issued instruction, a command center module interpreting the possible action in response to the instruction based on the data structure and a service module directed by the command center module to execute the possible action.

### FIELD OF THE INVENTION

The present invention relates to a technology for executing a workflow on a computer. More particularly, the present invention relates to an operating environment system and a method for an improved efficiency of a workflow executed on a computer.

### BACKGROUND OF THE INVENTION

In today automatic working environment, a huge of information is involved and has a critical effect on the overall working efficiency. In this regard, a lot of information managing and processing software is under development in request for better automatic information operating efficiency so that clerks involved in a specific workflow may be benefited with convenience brought therefrom.

There is some auxiliary software set forth for assisting in processing of a workflow on a computer. For example, U.S. Pat. No. 6,698,013 disclosed a real time monitor system capable of documentalizing and tracking an action and event made by a user when establishing, developing and maintaining a software system. By means of such monitor system, the action and event made by the user on the edited source codes for developing a system may be detected and recorded through an environment, such as editing and revising actions. In addition, information associated with the revising action may be recorded, such as date, time, spent time, revised position and the like. In addition, an action used to operate a program module in the software is recorded in an action pattern, such as inserting, searching, replacing and the like. Further, the software editing behavior of the user may also be detected, with which an executable method associated with an article parameter may be displayed in a window when a specific symbol associated with the article parameter is inputted. As such, the time for referring to a reference book may be saved and thus the operating efficiency of the user may be promoted. In addition, the information processed by the monitor system may be generated in a list form, which may be presented on some business-use application software such as Microsoft Word, Access and Excel. With the ability of detection on the user's action or event, the user's efficiency of program editing may be enhanced.

U.S. Patent No. disclosed a file system and a method for managing a file system, in which each file is defined with a token. When the file is executed in the file system, any information associated with the token of the file is processed.

Although the above mentioned technologies may facilitate a specific file or software to be processed, they can not assist the user in an entire workflow processed on the computer by monitoring the user's operating behavior, which can be the most wanted tool for the workflows generally utilized in the enterprises and other organizations.

In the case of setting forth and filing a patent application, a multitude of steps have to be undertaken so that the patent application may be successfully filed. These steps comprise setting forth of patent application, prior art arranging, specification drafting, briefing providing, patent application assessing and the like. Among them, the setting forth of patent application is associated with the proposing scheme, required information and associated clerk of the patent application, among others. The prior art arranging step is associated with the requirement and arrangement of the prior art, among others. The patent application drafting is associated with the document format setting and acquirement of the document copy associated with the patent application, among others. The briefing providing step is associated with the format adopting and points for attention. The patent application assessing is associated with the persons involved in the patent application, assess time, place and scheme.

For the above steps to be undertaken, several kinds of application software should be used, such as Microsoft Word, Excel, Outlook and CAD (Pro E and SolidWorks). Specifically, the user has to enter these application software repeatedly and manually access the data and information required for the specific workflow, resulting in a discontinuous data and information acquiring process. Furthermore, since the data and information are not centralized at some specific places, the proposing and filing process of the patent application can not be efficiently undertaken, the clerk has to spend lots of time in searching, arranging and inducing the data and information which are likely to be stored in a server other than the clerk's computer and the clerk is required to clarify the whole operating flow for the workflow. Accordingly, there is a need of a dedicated auxiliary operating environment so that the clerk may be assisted in the process for the workflow conducted on the computer.

Aside from the personal computer operating environment, kinds of information managing system are also widely used in the today office environment so that the huge information associated with the company may be efficiently managed, such as CRM, PDM and ERP. Among them, the CRM is associated with information of client managing affairs and client's requirement affairs, the PDM which is associated with information of product research and development affairs, ERP is associated with information of company management affairs. These information managing systems are related to different information managing mechanisms. The clerk or a project manager has to enter the information managing systems one by one so that he/she can acquire, arrange and process all the information that he/she desire to access. Since the operating platform which the clerk operates on is separated with these information managing systems, the clerk has to alter his/her usual operating practice and thus operating inconvenience is arisen.

Therefore, there is a need to provide a mechanism for the clerk to promote his/her efficiency with respect to a workflow undertaken on the computer, the mechanism being capable of integrating all the application software existing in the working environment so that all the data and information which are likely to be helpful to the clerks may efficiently circulate for all the clerks. As such, each of the clerks can acquire, arrange and process the data and information that he/she would like to access in a specific workflow.

After a long intensive series of experiments and researches, the inventor finally sets forth an operating environment system and a method for an improved efficiency of a workflow executed on a computer, which may effectively overcome the demerits existing in the prior art.

### SUMMARY OF THE INVENTION

It is, therefore, an object of the present invention to provide a technology for improving an operating efficiency of a workflow executed on a computer.

In accordance with an aspect of the present invention, a method for forming an action pattern for a workflow executed on a computer, comprising the steps of analyzing the workflow to define an operating range for the workflow; defining the operating range as a plurality of operating steps and a sequence thereof; defining at least a respective possible next action for an action generated from each of the operating steps; defining an information structure having information associated with the action and the at least a respective possible next action; defining a condition for an execution of the at least a respective possible next action; defining an input and an output for the at least a respective possible next action; defining a procedure required by the at least a respective possible next action; defining an execution result for the at least a respective possible next action after the execution thereof; establishing a transitional action pattern based on the defined operating range for the workflow, the plurality of operating steps, the sequence thereof, the at least a respective possible next action, the information structure, the condition for the execution of the at least a respective possible next action, the input, the output, the procedure and the execution result; and executing the above steps repeatedly so as to obtain the action pattern.

In accordance with another aspect of the present invention, a method for executing a workflow on a computer, comprising the steps of establishing an action pattern having a form of a data structure for information associated with at least a respective possible next action with respect to an action made on an application software; detecting and intercepting the action made on the application software; executing at least a respective service action corresponding to the action based on the action pattern; and displaying at least an execution result to a user in a specific manner.

In accordance with still another aspect of the present invention, an operating environment system for executing a workflow on a computer is disclosed, comprising a plurality of application softwares embedded in an operating system (OS) on the computer; an integrated operating environment embedded in the OS and on which a user executes the workflow, comprising: an action pattern module having an action pattern describing at least a respective possible next action for an action made with information associated therewith and taking a form of a data structure; a plug-in component module having a plurality of plug-in components, monitoring and intercepting the action and transmitting information associated with the intercepted action; a service module having a plurality of service units; and a command center module receiving and interpreting the information associated with the intercepted action and dictating a respective one of the plurality of service units to execute each of the at least a service action corresponding to the intercepted action based on the action pattern.

With the use of the inventive operating environment system and method, the clerk can acquire, arrange and process the data and information that he/she would like to access in a workflow undertaken on the computer without the need of entering repeatedly the multiple information managing system. Namely, the clerk may utilize a single application system to achieve an optimal working efficiency and have a work guide, exempting the demerits generally encountered by utilizing the prior art.

Other objects, advantages and efficacies of the present invention will be described in detail below taken from the preferred embodiments with reference to the accompanying drawings.

### BRIEF DESCRIPTION OF THE DRAWINGS

The foregoing summary, as well as the following detailed description of the preferred embodiments, is better understood when read in conjunction with the appended drawings. It is understood, however, that the invention is not limited to the specific methods and disclosed or illustrated. In the drawings:

FIG. 1 is a block diagram of an operating environment system for executing a workflow executed on a computer according to the present invention;

FIG. 2 is an exemplary data structure for an action pattern established for the operating environment system shown in FIG. 1;

FIG. 3 is a flowchart illustrating a method for establishing the data structure of the action pattern shown in FIG. 2; and

FIG. 4 is a method for an improved efficiency of the workflow executed on the computer by executing an application software according to the present invention.

### DETAILED DESCRIPTION OF THE PREFERRED EMBODIMENT

The present invention discloses an operating environment system and a method for executing a workflow on a computer, which will be described through the preferred embodiment with reference to the appended drawings.

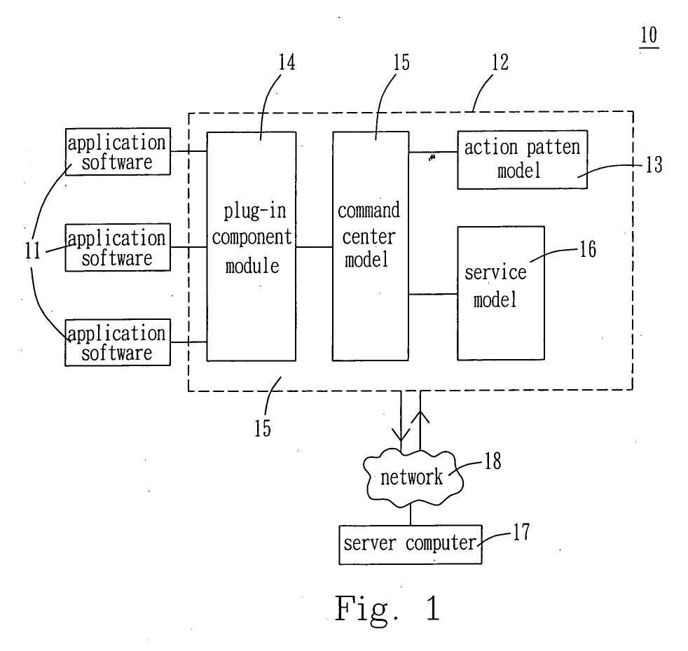

Referring to FIG. 1, a functional block diagram of the operating environment system for executing a workflow on a computer is shown therein. As shown, the operating environment system 10 comprises a plurality of application softwares 11 and an integrated operating environment 12. The application softwares 12 and integrated operating environment 12 are embedded an operating system (OS) on the computer (not shown). In conducting a workflow on the computer, the integrated operating environment 12 is used as a platform on which the user operates the application software, i.e. performs user actions on the application softwares, to complete the workflow with the aid of the operating environment system 10.

The integrated operating environment 12 comprises an action pattern module 13, a plug-in component module 14, a command center module 15 and a service module 16.

The action pattern module 13 has information describing at least a possible next user action which will be made by the user, which is preferably provided in a specific data structure form. The detail of the action pattern module 13 will be further described in the following.

The plug-in component module 14 has a plurality of plug-in components and used to detect an operating status of the user. When a user action is made, the user action is detected and intercepted and further transmitted to the command center module 15.

Upon receiving the user action, the command center module 15 refers to the content of the data structure stored in action pattern module 13 to obtain at least a possible next user action corresponding to the user action. Then, the command center 15 dictates the service module 16 to execute at least a service action for the user action based on the result obtained from the action pattern module 13.

The service module 16 has a plurality of service units so that executing several service actions concurrently may be possible. Further, each of the service units has to be given an initial setting so that it may be dynamically loaded into the integrated operating environment under the monitor and control of the command center 15.

Specifically, when a specific workflow is to be undertaken, the user can enter and utilize the operating environment system 12 to finish the workflow for convenience and speed reasons. Assuming the user desires to initialize the application software Microsoft Word as a beginning step of the workflow, he is required to initialize a plug-in, which is similar to the messaging software MSN (Microsoft Network), so that Microsoft Word will be automatically initialized. Next, the user may input data to or acquire data from on Microsoft Word. In the case of another application software existing in the computer, the initialization procedure for the operating environment system 12 is identical.

When the data is completely inputted into Microsoft Word, the user has generally to save them. Upon saving the data, the user action “save” is detected and intercepted by the plug-in component module 14. Then, the plug-in component module 14 sends the user action to the command center module 15. In response to the received user action, the command center module 15 refers to the data structure in the action pattern module 13 so as to obtain at least a possible next user action and information associated therewith. Next, the command center module 15 dictates and monitors the service module 16 to execute the possible next user action, termed herein as “service action”. Prior to the execution of the service module 16, the service module 16 has to be given an initial setting so that it may be dynamically loaded into the integrated operating environment 12 and monitored by the command center module 15. The service action is thus termed since the possible next action is automatically generated by the operating environment system 12 in response to a user action.

In addition, the operating environment system 10 may further comprise a server computer 17 so that the above mentioned function may be achieved with respect to data and information of an application software stored in a remote end. In such system 10 with the server computer 17, the server computer 17 is communicatively connected to a plurality of information managing systems (not shown) such as CRM, PDM and ERP. When the user performs an application software and requires specific data or information stored in one of the information managing systems when performing a workflow on his/her computer, the operating environment system 12 requests the server computer 17 via a network 18 to fetch the required data or information from the information managing systems. The network may be the generally used intranet and Internet. Since all clerks involved in the same workflow may enter the server computer 17 concurrently, the workflow may be finished with cooperation among the involved clerks.

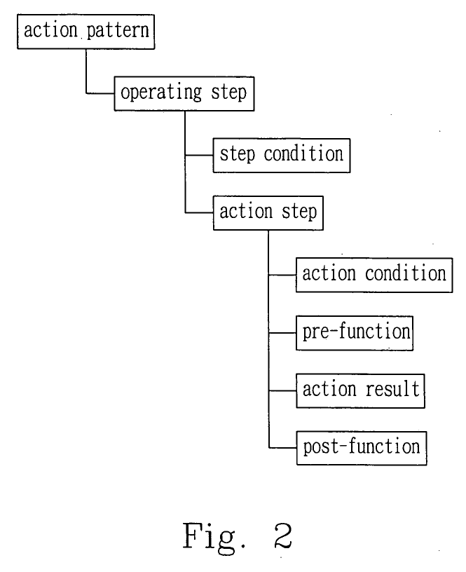

The following description will be made to the data structure of the action pattern with reference to FIG. 2. The data structure is a tree structure having a tree tail and a tree head and comprises, from the tree tail to the tree head, a first to a seven structure nodes. The first structure node contains information associated with a plurality of operating steps and a sequence thereof. The second structure node contains information associated with the possible next user action generated from each of the operating steps. The third structure node contains information associated with an information structure of each of the possible next action. The fourth structure node contains information associated with a condition for an execution for the possible next action. The fifth structure node contains information associated with an input and an output for each of the possible next action. The sixth structure node containing information associated with a procedure required by the possible next action. The seventh structure node contains information associated with the execution result for the possible next action after the execution thereof. The data structure may be described with the Extendable Markup Language (XML). Although the data structure of the action pattern is thus described, the present invention contemplates all the action patterns deduced by the same principle. For example, the number of the structure nodes may be greater or less than seven.

When a user action is made and intercepted by the command center module 15, the command center module 15 refers to the action pattern with a process in a specific sequence to complete the possible next user action. At first, locating a structure node associated with the operating step matching with the user action. Next, acquiring the structure node associated with the operating step. Next, confirming whether any condition for executing the possible next user action is met. If such as a condition is confirmed, then entering an action structure node corresponding thereto. Otherwise, the process leaves the action pattern. In the structure node associated with the action, confirming whether any action condition for the possible next user action is met. If yes, the command center module 15 dictates the corresponding service unit to execute a pre-function, an action result and a post-function associated with the action. In the above, the pre-function may be collecting of the information executed by the user, connecting the information managing systems and the like. The post-function may be informing of the information as to completion of the action to a system manage of the computer or other users.

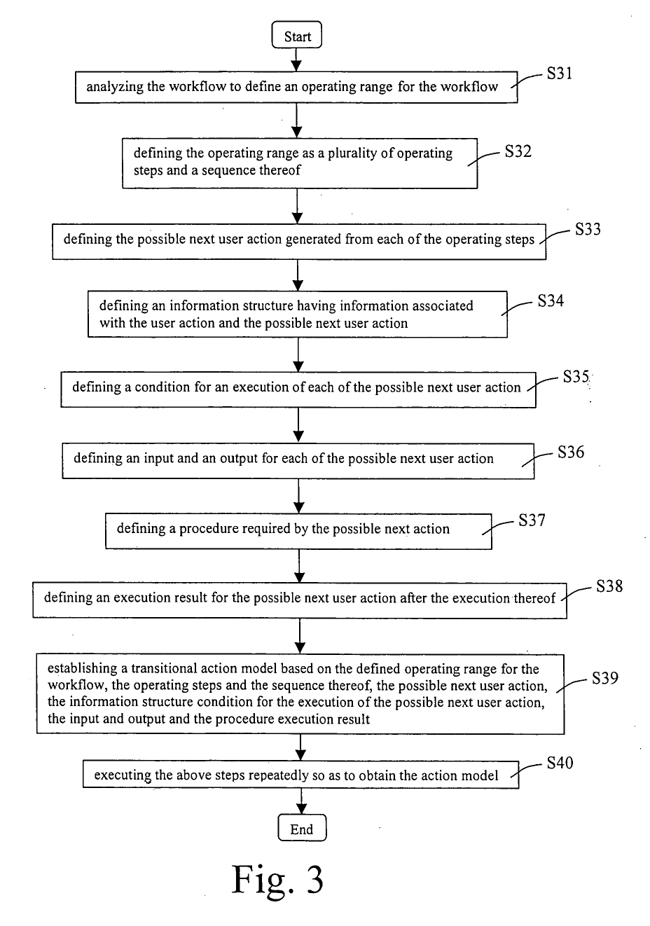

Referring to FIG. 3, a flowchart of a method for forming the above action pattern is illustrated therein. As shown, the method comprises the following steps. First, analyzing the workflow to define an operating range for the workflow (S31). Next, defining the operating range as a plurality of operating steps and a sequence thereof (S32). Next, defining the possible next user action generated from each of the operating steps (S33). Next, defining an information structure having information associated with the user action and the possible next user action (S34). Next, defining a condition for an execution of each of the possible next user action (S35). Next, defining an input and an output for each of the possible next user action (S36). Next, defining a procedure required by the possible next action (S37). Next, defining an execution result for the possible next user action after the execution thereof (S38). Next, establishing a transitional action model based on the defined operating range for the workflow, the operating steps and the sequence thereof, the possible next user action, the information structure condition for the execution of the possible next user action, the input and output and the procedure execution result (S39). Thereafter, executing the above steps repeatedly so as to obtain the action model (S40).

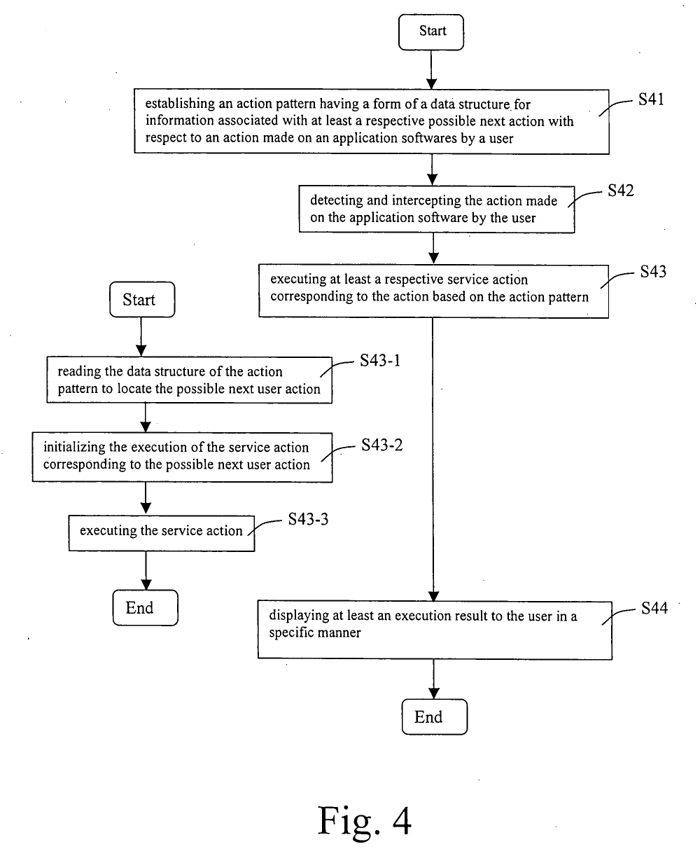

FIG. 4 is a flowchart of a method for executing a workflow on a computer according to the present invention. The method comprises the following steps. First, establishing an action pattern having a form of a data structure for information associated with at least a respective possible next action with respect to an action made on an application softwares by a user (S41). Next, detecting and intercepting the action made on the application software by the user (S42). Then, executing at least a respective service action corresponding to the action based on the action pattern (S43). Finally, displaying at least an execution result to the user in a specific manner (S44).

In an embodiment, the step S43 comprises the following steps: reading the data structure of the action pattern to locate the possible next user action (S43-1), initializing the execution of the service action corresponding to the possible next user action (S43-2), and executing the service action (S43-3). In some situations, access to some application software requires the user to input his/her account and password. At this time, the method further comprises a step of logically processing a set of user-associated data. In an embodiment, the step of logically processing the set of user-associated data comprises the steps of identifying a set of user's input data and collecting the set of user's input data. To access the data or information stored in a remote end and perform the workflow concurrently for the involved clerks, the step S43 comprises the following steps: communicatively connecting a server through a network, communicatively connecting the server to a plurality of information managing systems each having data or information therein, and fetching a specific set of data or information in one of the information managing systems through the network to the computer so as to be used by the application software on the computer when a user operates the application software and makes the user action to access the set of data or information. Likewise, the mentioned step of logically processing a set of user-associated data is required since the information managing systems located in the remote end may possibly require the user's account and password. In the above, the step S44 may be performed by displaying the set of data or information required by the user on the application software. In addition, the data structure is identical to that described with respect to the operating environment system of the present invention.

With the use of the system and method of the present invention, the user may access the data or information he/she requires when performing a specific workflow without the need of entering repeatedly the multiple information managing system. Namely, the clerk may utilize a single application system to achieve an optimal working efficiency and have a work guide, exempting the demerits generally encountered by utilizing the prior art. In the case of using the application software on the server computer or the remote information managing systems, the team cooperation purpose may be achieved up to a considerable extent.

In addition to the above embodiments, other embodiments may be possible. For instance, the possible next action may be automatically generated by the integrated operating environment and the method of the present invention for not only a user action but also an action generated automatically on the computer.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for forming an action pattern for a workflow executed on a computer, comprising the following steps:
analyzing the workflow to define an operating range for the workflow;
defining the operating range as a plurality of operating steps and a sequence thereof;
defining at least a respective possible next action for an action generated from each of the operating steps;
defining an information structure having information associated with the action and the at least a respective possible next action;
defining a condition for an execution of the at least a respective possible next action;
defining an input and an output for the at least a respective possible next action;
defining a procedure required by the at least a respective possible next action;
defining an execution result for the at least a respective possible next action after the execution thereof;
establishing a transitional action pattern based on the defined operating range for the workflow, the plurality of operating steps, the sequence thereof, the at least a respective possible next action, the information structure, the condition for the execution of the at least a respective possible next action, the input, the output, the procedure and the execution result; and
executing the above steps repeatedly so as to obtain the action pattern.

2. The method as claim in claim 1, wherein the at least a respective possible next action is a service action for achieving an execution of the workflow.

3. The method as claimed in claim 1, wherein the information of the information structure describes the workflow with an Extendable Markup Language (XML).

4. A data structure for describing an action pattern for a workflow executed on a computer, comprising:
a structure node containing information associated with a plurality of operating steps and a sequence thereof;
a structure node containing information associated with at least a respective possible next action generated from each of the plurality of operating steps with respect to an action;
a structure node containing information associated with an information structure of the at least a respective possible next action;
a structure node containing information associated with a condition for an execution for the at least a respective possible next action;
a structure node containing information associated with an input and an output for the at least a respective possible next action;
a structure node containing information associated with an automatic procedure required by the at least a respective possible next action; and
a structure node containing information associated with an execution result for the at least a respective possible next action after the execution thereof.

5. The data structure as claimed in claim 4, wherein the data structure has a tree tail and a tree head and described with an Extendable Markup Language (XML) and the structure nodes in the data structure are arranged from the tree tail to the tree head.

6. The data structure as claimed in claim 5, wherein the action is a user action made by a user.

7. An operating environment system for executing a workflow on a computer, comprising:
a plurality of application softwares embedded in an operating system (OS) on the computer;
an integrated operating environment embedded in the OS and on which a user executes the workflow, comprising:
an action pattern module having an action pattern describing at least a respective possible next action for an action made with information associated therewith and taking a form of a data structure;
a plug-in component module having a plurality of plug-in components, monitoring and intercepting the action and transmitting information associated with the intercepted action;
a service module having a plurality of service units; and
a command center module receiving and interpreting the information associated with the intercepted action and dictating a respective one of the plurality of service units to execute each of the at least a service action corresponding to the intercepted action based on the action pattern.

8. The operating environment system as claimed in claim 7, wherein the data structure, further comprising:
a structure node containing information associated with a plurality of operating steps and a sequence thereof;
a structure node containing information associated with the at least a respective possible next action generated from each of the plurality of operating steps;
a structure node containing information associated with an information structure of the at least a respective possible next action;
a structure node containing information associated with a condition for an execution for the at least a respective possible next action;
a structure node containing information associated with an input and an output for the at least a respective possible next action;
a structure node containing information associated with a respective procedure required by the at least a respective possible next action; and
a structure node containing information associated with the execution result for the at least a respective possible next action after the execution thereof.

9. The operating environment system as claimed in claim 8, wherein the data structure is a tree structure having a tree tail and a tree head and described with an Extended Markup Language (XML) and the structure nodes in the data structure are ranged from the tree tail to the tree head.

10. The operating environment system as claimed in claim 9, wherein the information structure comprises information associated with the action and the execution of the at least a respective possible next action.

11. The operating environment system as claimed in claim 7, further comprising a server communicatively connected to a plurality of information managing systems each having data or information therein, and connected to the computer through a network, and fetching a specific set of data or information from the data or information in one of the plurality of information managing systems through the network to the computer so as to be used by a corresponding one of the plurality of application softwares on the computer when the user operates the plurality of application softwares and makes the action to access the specific set of data or information.

12. The operating environment system as claimed in claim 11, wherein the data structure, further comprising:
a structure node containing information associated with a plurality of operating steps and a sequence thereof;
a structure node containing information associated with the at least a respective possible next action generated from each of the plurality of operating steps;
a structure node containing information associated with an information structure of the at least a respective possible next action;
a structure node containing information associated with a condition for an execution for the at least a respective possible next action;
a structure node containing information associated with an input and an output for the at least a respective possible next action;
a structure node containing information associated with a respective procedure required by the at least a respective possible next action; and
a structure node containing information associated with the execution result for the at least a respective possible next action after the execution thereof.

13. The operating environment system as claimed in claim 12, wherein the data structure is a tree structure having a tree tail and a tree head and described with an Extended Markup Language (XML) and the structure nodes in the data structure are ranged from the tree tail to the tree head.

14. The operating environment system as claimed in claim 13, wherein the information structure comprises information associated with the action and the execution of the at least a respective possible next action.

15. The operating environment system as claimed in claim 7, wherein the action is a user action made by the user.

16. A method for executing a workflow on a computer, comprising the following steps:
establishing an action pattern having a form of a data structure for information associated with at least a respective possible next action with respect to an action made on an application software;
detecting and intercepting the action made on the application software;
executing at least a respective service action corresponding to the action based on the action pattern; and
displaying at least an execution result to a user in a specific manner.

17. The method as claimed in claim 16, wherein the step of executing the at least a respective service action corresponding to the action based on the action pattern comprises the following steps:
reading the data structure of the action pattern to locate the at least a respective possible next action;
initializing an execution of the at least a respective service action corresponding to the at least a respective possible next action; and
executing the at least a respective service action.

18. The method as claimed in claim 17, further comprising a step of logically processing a set of user-associated data.

19. The method as claimed in claim 18, wherein the step of logically processing the set of user-associated data, further comprising the following steps:
identifying a set of user's input data; and
collecting the set of user's input data.

20. The method as claimed in claims 16, wherein the step of executing the at least a respective service action, further comprising the following steps:
communicatively connecting a server through a network;
communicatively connecting the server to a plurality of information managing systems each having data or information therein; and
fetching a specific set of data or information in one of the plurality of information managing systems through the network to the computer so as to be used by the application software on the computer when a user operates the application software and makes the action to access the specific set of data or information.

21. The method as claimed in claim 20, further comprising a step of logically processing a set of user-associated data.

22. The method as claimed in claim 21, wherein the step of logically processing the set of user-associated data, further comprising the following steps:
identifying a set of user's input data; and
collecting the set of user's input data.

23. The method as claimed in claim 20, wherein the step of displaying the execution result to the user in the specific manner, further comprising the following step:
displaying the specific set of data or information required by the user on the application software.

24. The method as claimed in claim 16, wherein the data structure, further comprising:
a structure node containing information associated with a plurality of operating steps and a sequence thereof;
a structure node containing information associated with the at least a respective possible next action generated from each of the plurality of operating steps;
a structure node containing information associated with an information structure of each of the at least a respective possible next action;
a structure node containing information associated with a condition for an execution for the at least a respective possible next action;
a structure node containing information associated with an input and an output for the at least a respective possible next action;
a structure node containing information associated with a procedure required by the at least a respective possible next action; and
a structure node containing information associated with the execution result for the at least a respective possible next action after the execution thereof.

25. The method as claimed in claims 24, wherein the data structure is a tree structure having a tree tail and a tree head and described with an Extendable Markup Language (XML), and the structure nodes in the data structure are ranged from the tree tail to the tree head.

26. The method as claimed in claim 24, wherein the information structure, further comprising information associated with the action and the execution of the at least a respective possible next action.

27. The method as claimed in claim 20, wherein the data structure, further comprising:
a structure node containing information associated with a plurality of operating steps and a sequence thereof;
a structure node containing information associated with the at least a respective possible next action generated from each of the plurality of operating steps;
a structure node containing information associated with an information structure of each of the at least a respective possible next action;
a structure node containing information associated with a condition for an execution for the at least a respective possible next action;
a structure node containing information associated with an input and an output for the at least a respective possible next action;
a structure node containing information associated with a procedure required by the at least a respective possible next action; and
a structure node containing information associated with the execution result for the at least a respective possible next action after the execution thereof.

28. The method as claimed in claims 27, wherein the data structure is a tree structure having a tree tail and a tree head and described with an Extendable Markup Language (XML), and the structure nodes in the data structure are ranged from the tree tail to the tree head.

29. The method as claimed in claim 27, wherein the information structure, further comprising information associated with the action and the execution of the at least a respective possible next action.

30. The method as claimed in claim 16, wherein the action is a user action made by the user.
